(19) United States
(12) Patent Application Publication
(10) Pub. No.: US 2012/0132862 A1
(43) Pub. Date: May 31, 2012

(54) CARBON NANOTUBE DISPERSION AND METHOD OF PREPARING TRANSPARENT ELECTRODE USING THE CARBON NANOTUBE DISPERSION

(75) Inventors: Hyeon-jin SHIN, Yongin-si (KR); Jae-young CHOI, Yongin-si (KR); Seong-jae CHOI, Yongin-si (KR); Seon-mi YOON, Yongin-si (KR)

(73) Assignee: SAMSUNG ELECTRONICS CO., LTD, Suwon-si (KR)

(21) Appl. No.: 12/023,924

(22) Filed: Jan. 31, 2008

(30) Foreign Application Priority Data
May 14, 2007 (KR) 10-2007-0046670

(51) Int. Cl. H01B 1/24; B05D 5/12; B82Y 30/00; B82Y 40/00

(52) U.S. Cl. 252/511; 427/108; 977/742; 977/932; 977/892

(57) ABSTRACT

Provided is a carbon nanotube dispersion including: carbon nanotubes, a solvent, and a dispersant, in which a mutifunctional ethylene oxide-propylene oxide block copolymer acts as the dispersant. The carbon nanotube dispersion provides excellent dispersion stability in aqueous and organic systems. Therefore, the carbon nanotube dispersion is suitable for a transparent electrode.

### CROSS-REFERENCE TO RELATED PATENT APPLICATIONS

This application claims the benefit of Korean Patent Application No. 10-2007-0046670, filed on May 14, 2007, in the Korean Intellectual Property Office, the disclosure of which is incorporated herein in its entirety by reference.

### BACKGROUND OF THE INVENTION

1. Field of the Invention

The present invention relates to a carbon nanotube dispersion, and more particularly, to a carbon nanotube dispersion enabling carbon nanotube dispersion in both aqueous and organic systems having an excellent dispersion stability.

2. Description of the Related Art

Doctor Iijima discovered carbon nanotubes in 1991 and research into carbon nanotubes (CNTs) has been performed ever since. In CNTs, carbon atoms are connected together to form a hexagonal, beehive-like-pattern tube. The resulting tube has a nanometer diameter and various useful properties.

For example, CNTs have various electrical properties according to their structure and diameter. That is, according to their structure and diameter, CNTs can act as an insulator, a semiconductor, or a conductor. For example, a spiral CNT acting as an insulator may be changed in shape or chirality so that free electrons in the spiral CNT move in a different way. As a result, the CNT can become a conductor allowing electrons to move relatively freely through the structure, or it can become a semiconductor if the new shape or adjusted chirality creates a barrier to electron movement.

CNTs are mechanically strong and chemically stable. They can have semi-conducting properties or conducting properties. Structurally, they have a small diameter, a long length, and empty space within their tubular form. Due to these properties, CNTs are suitable for use in many applications including: a flat panel display device, a transistor, an energy-storage medium, various nano-sized electrical devices, etc.

When CNTs are formed into a conductive layer or are used in the process of manufacturing various electrical devices, CNTs should be effectively dispersed in a matrix, such as a solvent or a binder. CNTs, however, tend to cohere together in bundles in the matrix due to Van der Waals force, so that CNTs have very low solubility with respect to water or other solvents and low processability.

When CNTs cohere in a matrix their unique properties disappear. And, if CNTs cohere in a thin film, uniformity of the thin film may deteriorate.

Specifically, when CNTs act as a semi-conducting material and are used in transistors, or act as a conducting material and are used in electrodes, that is, when CNTs are used in display applications requiring transparent properties, the importance of dispersing CNTs increases. Specifically, when the dispersion fails to separate CNTs from each other and some CNTs cohere in bundles, a display device including such CNTs may not be completely transparent even though the display device may have similar performance.

In addition, it is difficult to sufficiently disperse CNTs using commercially available dispersants due to unique properties of CNTs. Accordingly, new dispersants have been developed to uniformly disperse or dissolve CNTs in a solvent or a binder.

For example, Korean Patent Publication No. 2001-102598 discloses a CNT to which an alkyl group is chemically bonded, Korean Patent Publication No. 2003-86442 discloses a CNT having high solubility covered by a polymer which physically interacts with the CNT, and Korean Patent Publication No. 2005-97711 discloses a CNT to which at least one kind of a functional group selected from the group consisting of a cyan group, an amine group, a hydroxyl group, a carboxylic group, a halide group, a nitric acid group, a thiocyan group, a thiosulfuric acid group, and a vinyl group is bonded. Although these techniques described above may be useful to improve dispersibility in part, a surface modification process is utilized and thereby desirable properties of CNTs can be obscured.

Korean Patent Publication No. 004-103325 discloses a method of improving dispersibility of CNTs by treating the surface of the CNTs with fluoride, Korean Patent Publication No. 2005-110912 discloses a method of improving dispersibility of CNTs by sonicating the CNT-containing solution, and Japanese Patent Publication No. 2005-219986 discloses a carbon nanotube dispersion in which an aromatic polyamide is used as a dispersant. These methods described above, however, are unsuitable to obtain a complete dispersion of CNTs.

A carbon nanotube dispersion is prepared by dispersing CNTs in an aqueous solvent since carbon nanotube dispersants have very low dispersibility with respect to an organic solvent. To disperse a large amount of CNTs in an organic solvent, an excess amount of a dispersant needs to be added. Excess dispersant, however, may act as impurities, hindering properties of the CNTs in a given device. Accordingly, a method to efficiently disperse a great amount of CNTs in a organic solvent using a small amount of a dispersant, that is, a method of dispersing CNTs to a high concentration in a organic solvent needs to be developed.

Transparent conductive thin films have a wide range of applications requiring transparent and conductive properties, such as an image sensor, a solar cell, and various displays. Research into indium tin e oxide (ITO) as a transparent electrode material for use in a flexible display has been carried out. However, when a flexible display device including a transparent electrode formed of ITO is bended or folded, the thin film may be destroyed and thus, the lifetime of the device can be reduced.

Instead of the ITO electrode, a carbon nanotube dispersion can be coated on a transparent resin film to form a transparent electrode. In this method, however, CNTs should be uniformly dispersed to a high concentration and the decrease in conductivity due to the dispersant should be minimized. However, there is no dispersant that complies with the requirements described above.

Accordingly, there is a need for a carbon nanotube dispersion having high dispersibility of CNTs, to secure high transparency, while maintaining the desirable electrical properties of the dispersion.

### SUMMARY OF THE INVENTION

The present invention provides a carbon nanotube dispersion enabling carbon nanotube dispersion in both aqueous and organic systems and having an excellent dispersion stability.

The present invention also provides a method of preparing a transparent electrode using the carbon nanotube dispersion.

According to an aspect of the present invention, there is provided a carbon nanotube dispersion comprising: carbon nanotubes; a solvent; and a dispersant, wherein a multifunctional ethylene oxide-propylene oxide block copolymer acts as the dispersant.

The multifunctional ethylene oxide-propylene oxide block copolymer may be a difunctional ethylene oxide-propylene block copolymer or a tetrafunctional ethylene oxide-propylene oxide block copolymer.

The difunctional ethylene oxide-propylene oxide block copolymer may be a compound represented by Formula 1 or Formula 2:

HO-{[A]ₙ-[B]ₘ}_{y}-[A]ₓ-OH; and [Formula 1]

HO-{[B]ₙ-[A]ₘ}_{y}-[B]ₓ-OH [Formula 2]

where A is an ethylene oxide repeat unit, B is a propylene oxide repeat unit, n, m, and x are integers where n+m+x>10, and y is an integer where 1<y<100.

The tetrafunctional ethylene oxide-propylene oxide block copolymer may be a compound represented by Formula 3 or Formula 4:

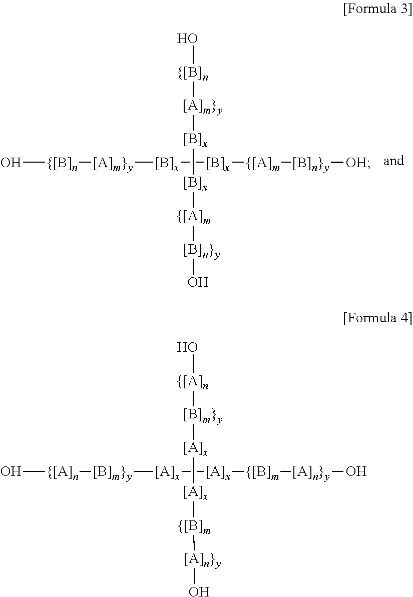

where A is an ethylene oxide repeat unit, B is a propylene oxide repeat unit, n, m, and x are integers where n+m+x>10, and y is an integer where 1<y<100.

The solvent comprises at least one selected from the group consisting of water, alcohols, amides, pyrrolidones, hydroxyesters, organic halides, nitro compounds, and nitrile compounds. Specifically, the solvent can be water, alcohols, amides, such as dimethylformamide (DMF), M-methyl pyrrolidone (NMP), an organic chloride, such as dichloromethane or dichlorobenzene.

The amount of carbon nanotubes may be in the range from 0.001 to 0.05 parts by weight and the amount of the dispersant is in the range from 0.01 to 0.3 parts by weight, based on 100 parts by weight of the solvent.

According to another aspect of the present invention, there is provided a method of preparing a transparent electrode, the method comprising: preparing a carbon nanotube dispersion comprising carbon nanotubes, a solvent, and a multifunctional ethylene oxide-propylene oxide block copolymer acting as a dispersant; coating the carbon nanotube dispersion on a transparent film; and drying the transparent film coated with the carbon nanotube dispersion.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating an interaction between a dispersant and carbon nanotubes in aqueous and organic solvents according to embodiments of the present invention;

FIG. 2 is a graphical view illustrating UV-VIS spectra of the carbon nanotube dispersions prepared according to Examples 1 through 8 and Comparative Example 1;

FIG. 3 is a graphical view illustrating UV-VIS spectra of the carbon nanotube dispersions prepared according to Examples 3, 9, 10, and 11 in which the concentration of dispersant differs; and

FIG. 4 is a graphical view of sheet resistance before and after the carbon nanotube dispersions prepared according to Examples 1 through 8 and Comparative Example 1 were cleansed to remove the dispersant.

### DETAILED DESCRIPTION OF THE INVENTION

The present invention will now be described more fully with reference to the accompanying drawings, in which exemplary embodiments of the invention are shown.

A carbon nanotube dispersion according to the present invention enables dispersion in aqueous and organic systems and has an excellent dispersion stability. The carbon nanotube dispersion includes carbon nanotubes; a solvent; and a dispersant. According to the present invention, a mutifunctional ethylene oxide-propylene oxide block copolymer acts as the dispersant.

The dispersant according to the present invention includes a solvent affinity part and a carbon nanotube affinity part in its molecule. Therefore, the dispersant can improve dispersibility of the carbon nanotubes in the solvent.

The multifunctional ethylene oxide-propylene oxide block copolymer can be a difunctional ethylene oxide-propylene oxide block copolymer or a tetrafunctional ethylene oxide-propylene oxide block copolymer.

The difunctional ethylene oxide-propylene oxide block copolymer can be a compound represented by Formula 1 or Formula 2:

HO-{[A]ₙ-[B]ₘ}_{y}-[A]ₓ-OH; and [Formula 1]

HO-{[B]ₙ-[A]ₘ}_{y}-[B]ₓ-OH [Formula 2]

where A is an ethylene oxide repeat unit,

B is a propylene oxide repeat unit,

n, m, and x are integers where n+m+x>10, and

y is an integer where 1<y<100.

In the difunctional ethylene oxide-propylene oxide block copolymer, the propylene oxide repeat unit can be an n-propylene oxide repeat unit or an isopropylene oxide repeat unit.

A method of preparing the difunctional ethylene oxide-propylene oxide block copolymer will now be described in detail. First, ethyleneoxide(CH₂CH₂O) reacts with water to form an ethylene glycol (HO(CH₂)₂OH) and then, the ethylene glycol (HO(CH₂)₂OH) is polymerized to form a polyethylene glycol (PEG) block. Then, a polypropylene glycol (PPG) block is formed in the same manner as the polyethylene glycol (PEG) block. Then, the polypropylene glycol (PPG) block and the polyethylene glycol (PEG) block are mixed and polymerized together to obtain an ethylene oxide-propylene oxide block copolymer. Examples of the ethylene oxide-propylene oxide block copolymer include commercially available Pluronic® series produced by BASF Co.

The tetrafunctional ethylene oxide-propylene oxide block copolymer can be a compound represented by Formula 3 or Formula 4:

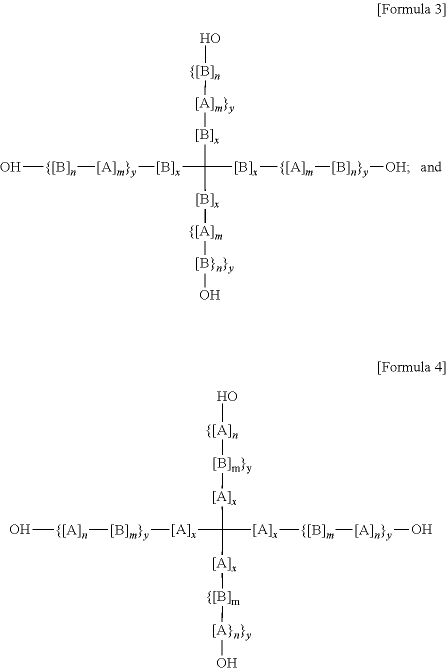

where A is an ethylene oxide repeat unit,

B is a propylene oxide repeat unit,

n, m, and x are integers where n+m+x>10, and

y is an integer where 1<y<100.

In the tetrafunctional ethylene oxide-propylene oxide block copolymer, the propylene oxide repeat unit can be an n-propylene oxide repeat unit or an isopropylene oxide repeat unit.

The tetrafunctional ethylene oxide-propylene oxide block copolymer can be prepared in the same manner as the difunctional copolymer, except that after the PEG block and the PPG block are prepared, the PEG block and the PPG block can be polymerized while a carbon tetrachloride (CCl₄) compound is added thereto. As a result, the tetrafunctional ethylene oxide-propylene oxide block copolymer can be obtained. Examples of the tetrafunctional ethylene oxide-propylene oxide block copolymer include commercially available Tetronic® series produced by BASF Co.

The multifunctional ethylene oxide-propylene oxide block-copolymer may have a number average molecular weight from 1000 to 25000.

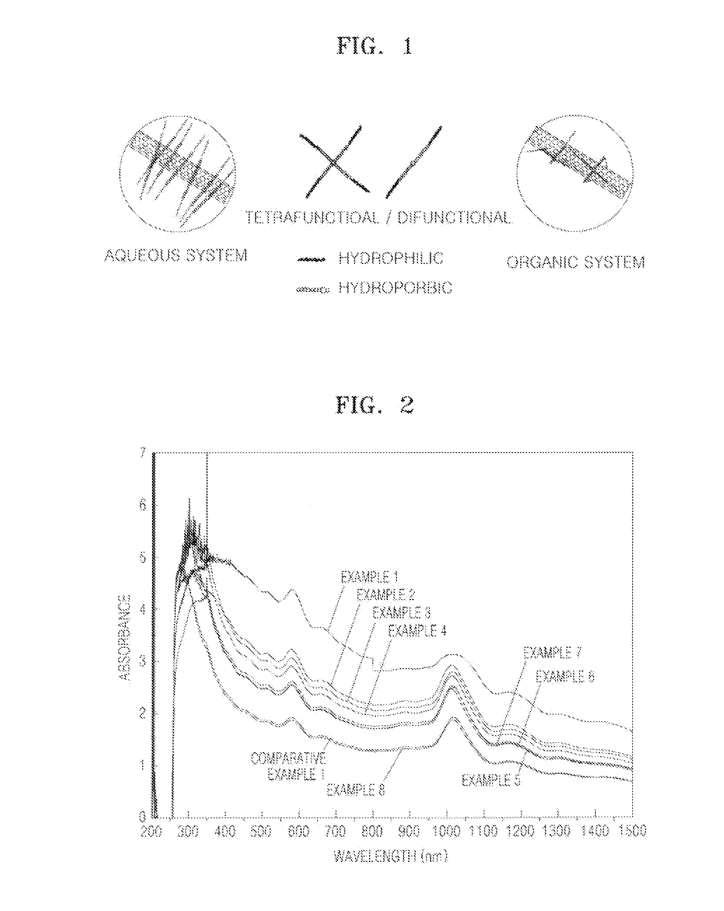

The mutifunctional ethylene oxide-propylene oxide block copolymer according to the present invention includes ethylene oxide having relative hydrophilic properties and a propylene oxide block having relative hydrophobic properties, so that the mutifunctional ethylene oxide-propylene oxide block copolymer allows dispersion in aqueous and organic solvents. That is, as schematically illustrated in FIG. 1, in aqueous and organic solvents, a hydroxyl part at the terminal of the ethylene oxide block interacts with the solvent, and a propylene oxide block part interacts with the carbon nanotubes to maintain their dispersed state. Since the hydroxyl part exists only at the terminals, as the molecular weight of the mutifunctional ethylene oxide-propylene oxide block copolymer increases and as the mutifunctional ethylene oxide-propylene oxide block copolymer has more propylene oxide block part, the mutifunctional ethylene oxide-propylene oxide block copolymer has more affinity to a organic solvent than an aqueous solvent.

In the multifunctional ethylene oxide-propylene oxide block copolymer according to the present invention, its hydrophobic part is attached to a carbon nanotube depending on the lengths of the ethylene oxide block and the propylene oxide block. Accordingly, carbon nanotubes can be dispersed in an organic solvent and an aqueous solvent according to the molecular weight of the mutifunctional ethylene oxide-propylene oxide block copolymer. Unlike the dispersant according to the present invention, a conventional dispersant is a polymer with charged long-chained hydrocarbonyl groups. The charged part of the conventional dispersant is formed in a micelle in water, and an alkyl part of the conventional dispersant is relatively hydrophobic and thus, a CNT is attached to the alkyl part. Accordingly, in the case of the conventional dispersant, only water can be used as a solvent. According to the present invention, however, carbon nanotubes can be dispersed in both organic aqueous solvents by controlling the relative polarity difference between the ethylene oxide block and the propylene oxide block, and the length of blocks. That is, the mutifunctional ethylene oxide-propylene oxide block copolymer can have hydrophilic properties and lipophlic properties according to lengths of the ethylene e oxide block or the propylene oxide block and the number of blocks.

The mutifunctional ethylene oxide-proylene oxide block copolymer according to the present invention can be difunctional or tetrafunctional so that the mutifunctional ethylene oxide-propylene oxide block copolymer can have two or four times more functional chains than a single functional dispersant and thus, more frequent contacts with the carbon nanotubes. Therefore, dispersibility of carbon nanotubes can be improved.

The solvent included in the carbon nanotube dispersion according to the present invention can be an aqueous solvent or an organic solvent. The solvent may include at least one element selected from the group consisting of water; alcohols, such as methanol, ethanol, isopropanol, propanol, butanol, terpineol, or the like; amides, such as dimethylformamide, dimethylacetoamide, or the like; pyrrolidones, such as N-methyl-2-pyrrolidone, N-ethylpyrrolidone, or the like; hydroxyesters, such as dimethylsulfoxide, γ-butyrolactone, lactic acid methyl, lactic acid ethyl, β-methoxyisobutyricmethyl, α-hydroxyisobutyricmethyl, or the like; organic halides, such as dichloroethane, dichlorobenzene, trichloroethane, or the like; nitro compounds, such as nitromethane, nitroethane, or the like; and nitrile compounds, such as acetonitrile, benzonitrile, or the like.

In the carbon nanotube dispersion, the amount of carbon nanotubes may be in the range from 0.001 to 0.05 parts by weight and the amount of the dispersant may be in the range from 0.01 to 0.3 parts by weight, based on 100 parts by weight of the solvent.

When the amount of the carbon nanotubes is less than 0.001 parts by weight, the carbon nanotubes may not show desired properties. On the other hand, when the amount of the carbon nanotubes is more than 0.05 parts by weight, the carbon nanotubes agglomerate and it is difficult to disperse them. When the amount of the dispersant is less than 0.01 parts by weight, the dispersing effect with respect to the carbon nanotubes may be low. On the other hand when the amount of the dispersant is more than 0.3 parts by weight, properties of the carbon nanotubes may deteriorate.

A method of preparing the carbon nanotube dispersion according to the present invention will now be described in detail. Carbon nanotubes, a dispersant, and a solvent are mixed together and then sonicated to disperse the carbon nanotubes in the solvent. The resultant sonicated carbon nanotube dispersion is centrifuged to precipitate impurities and carbon nanotube bundles having low dispersibility, and then, the precipitates are removed to obtain a final carbon nanotube dispersion.

The carbon nanotube dispersion according to the present invention can be prepared using a stirring or kneading device, such as an ultrasonic homogenizer, a spiral mixer, a planetary mixer, a disperser, or a hybrid mixer.

In the carbon nanotube dispersion according to the present invention, the carbon nanotubes can be easily dispersed in the solvent without affecting properties of the carbon nanotubes. In addition, even after the carbon nanotube dispersion is left to sit for a long period of time, the carbon nanotube dispersion shows excellent dispersion stability and excellent conductivity, and can be easily formed in a film of a desired shape.

A method of preparing a transparent electrode according to the present invention includes: preparing a carbon nanotube dispersion including carbon nanotubes, a solvent, and a multifunctional ethylene oxide-propylene oxide block copolymer acting as a dispersant, coating the carbon nanotube dispersion on a transparent film, and drying the transparent film coated with the carbon nanotube dispersion.

A transparent electrode prepared according to the method described above may have a transparency degree of 80% or more, specifically, of 85% or more, and a sheet resistance from 30 to 2000 kohm/cm², specifically, from 100 to 1000 kohm/cm².

Coating the carbon nanotube dispersion on the transparent film may be performed by spin coating, electrophoresis depositing, casting, inkjet printing, spraying, or offset printing.

The carbon nanotube dispersion can be dried at a temperature from room temperature to 200□.

The carbon nanotube dispersion according to the present invention includes the multifunctional ethylene oxide-propylene oxide block copolymer as a dispersant, so that the carbon nanotube dispersion has a high degree of dispersion. Therefore, the carbon nanotube dispersion is suitable for a transparent electrode. In addition, the multifunctional ethylene oxide-propylene oxide block copolymer does not affect electrical properties of the carbon nanotubes. To preserve electrical properties of the carbon nanotubes in the dispersion, the tetrafunctional ethylene oxide-propylene oxide block copolymer is more suitable than the difunctional ethylene oxide-propylene oxide block copolymer.

The transparent film can be a PET resin, a PES resin, a PEN resin, or the like.

After the drying process, excess dispersant, not combined with the carbon nanotubes and the solvent, can be cleansed using acetone or NMP. Therefore, adverse effects of the dispersant on the carbon nanotubes can be minimized.

The present invention will be described in further detail with reference to the following examples. These examples are for illustrative purposes only and are not intended to limit the scope of the present invention.

Preparation of Carbon Nanotube Dispersion

### EXAMPLE 1

40 mg of Pluronic® 123 that acts as a dispersant and 2 mg of single wall carbon nanotubes (Southwest) were added to 20 g of N-methyl-2-pyrrolidone(NMP). The mixture was placed in a sonic bath (35 kHz, 400 W) for 10 hours. Then, the resultant dispersion was centrifuged at 10,000 rpm for 10 minutes. Precipitated powder was removed from the centrifuged carbon nanotube solution to obtain a carbon nanotube dispersion.

### EXAMPLE 2

A carbon nanotube dispersion was prepared in the same manner as in Example 1, except that instead of Pluronic® 123, 40 mg of Tetronic® 704 was used as a dispersant.

### EXAMPLE 3

A carbon nanotube dispersion was prepared in the same manner as in Example 1, except that instead of Pluronic® 123, 40 mg of Tetronic® 150R1 was used as a dispersant.

### EXAMPLE 4

A carbon nanotube dispersion was prepared in the same manner as in Example 1, except that instead of Pluronic® 123, 40 mg of Tetronic® 90R4 was used as a dispersant.

### EXAMPLE 5

A carbon nanotube dispersion was prepared in the same manner as in Example 1, except that instead of Pluronic® 123, 40 mg of Tetronic® 304 was used as a dispersant.

### EXAMPLE 6

A carbon nanotube dispersion was prepared in the same manner as in Example 1, except that instead of Pluronic® 123, 40 mg of Tetronic® 908 was used as a dispersant.

### EXAMPLE 7

A carbon nanotube dispersion was prepared in the same manner as in Example 1, except that instead of Pluronic® 123, 40 mg of Tetronic® 1107 was used as a dispersant.

### EXAMPLE 8

A carbon nanotube dispersion was prepared in the same manner as in Example 1, except that instead of Pluronic® 123, 40 mg of Tetronic® 701 was used as a dispersant.

### EXAMPLE 9

A carbon nanotube dispersion was prepared in the same manner as in Example 1, except that instead of Pluronic® 123, 40 mg of Pluronic® F68 was used as a dispersant.

### EXAMPLE 10

A carbon nanotube dispersion was prepared in the same manner as in Example 3, except that the amount of the dispersant used was 100 mg.

### EXAMPLE 11

A carbon nanotube dispersion was prepared in the same manner as in Example 9, except that the amount of the dispersant used was 100 mg.

### COMPARATIVE EXAMPLE 1

A carbon nanotube dispersion was prepared in the same manner as in Example 1, except that the dispersant was not used.

### COMPARATIVE EXAMPLE 2

A carbon nanotube dispersion was prepared in the same manner as in Example 1, except that instead of Pluronic® 123, 100 mg of sodium dodecyl benzene sulfonate (NaDDBS) was used as a dispersant.

Dispersibility Test on Carbon Nanotube Dispersion

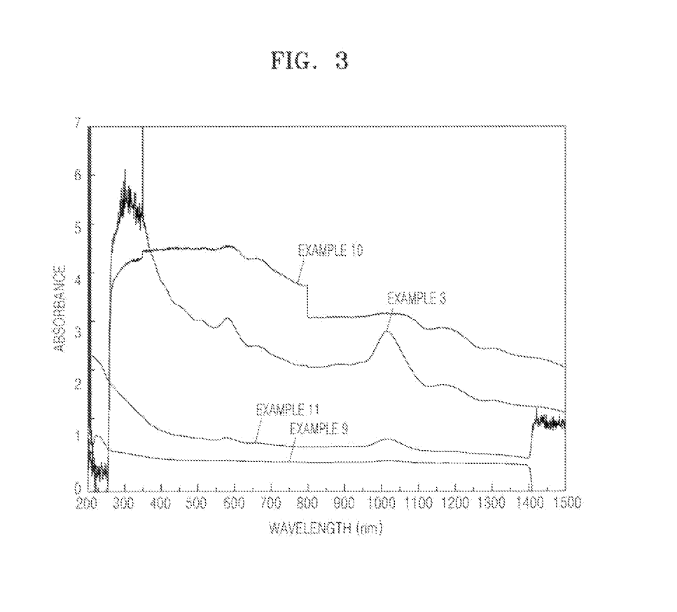

Absorbance of the carbon nanotube dispersions prepared according to Examples 1 through 8 and Comparative Example 1 was measured using a UV-VIS spectrophotometer (JASCO V-560) at a scanning speed of 400 nm/min in a wavelength range from 250 nm to 1500 nm. The results are shown in FIG. 2.

Referring to FIG. 2, it can be seen that the absorbance of the carbon nanotube dispersions including a dispersant prepared according to the present invention were higher than the absorbance of the carbon nanotube dispersion including only the solvent prepared according to Comparative Example 1. Such results show that the degree of dispersion of the carbon nanotubes using a dispersant is high.

FIG. 3 shows absorbance of the carbon nanotube dispersion including various concentrations of a dispersant prepared according to Examples 3, 10, 9, and 11. Referring to FIG. 3, it can be seen that as the concentration of the dispersant increases, the degree of dispersion of the carbon nanotubes increases.

Sheet Resistance

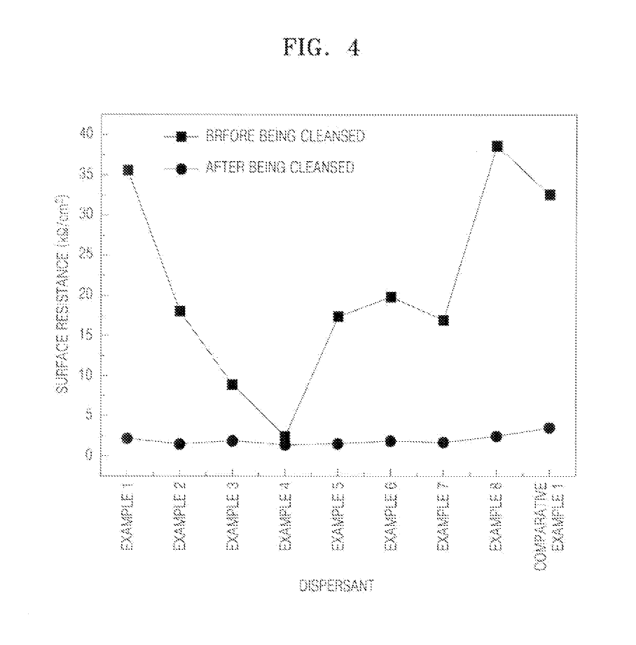

The absorbance of each of the carbon nanotube dispersions was measured at a UV wavelength of 600 nm. Then, the concentration of a carbon nanotubes in each of the carbon nanotube dispersions was adjusted to have the same absorbance as each other. Therefore, the carbon nanotube dispersions all contained the same amount of carbon nanotubes. Each of the carbon nanotube dispersions was formed into a bucky paper, and then, a sheet resistance of each of the carbon nanotube dispersions before and after being cleansed with NMP and acetone was measured. The results are shown in Table 1 and FIG. 4.

The sheet resistance was measured using a 4-probe measuring method.

TABLE 1

| | | | | Sheet |
|---|---|---|---|---|
| | | | Sheet | Resistance |
| | | Sheet | Resistance | (ohm/cm²) |
| | | Resistance | (ohm/cm²) | after being |
| | | (ohm/cm²) | after being | cleansed |
| | Molecular | Before being | cleansed one | two times |
| | Weight | cleansed | time with NMP | with acetone |
| Example 1 | 5750 | 35.58 | 30.14 | 2.187 |
| Example 2 | 5500 | 18.04 | 17.46 | 1.499 |
| Example 3 | 8000 | 8.891 | 11.12 | 1.887 |
| Example 4 | 6900 | 2.424 | 6.321 | 1.405 |
| Example 5 | 1650 | 17.37 | 14.51 | 1.556 |
| Example 6 | 25000 | 19.83 | 16.38 | 1.87 |
| Example 7 | 15000 | 16.92 | 15.31 | 1.715 |
| Example 8 | 3600 | 38.62 | 23.18 | 2.47 |
| Example 9 | 8400 | 29.36 | 55.04 | 33.66 |
| Example 10 | 8000 | 4.25 | 6.229 | 0.6963 |
| Example 11 | 8400 | 12.07 | 18.35 | 6.083 |
| Comparative | | 32.57 | 30.63 | 3.525 |
| Example 1 | | | | |

Referring to Table 1 and FIG. 4, it can be seen that the carbon nanotube dispersion according to the present invention showed a high sheet resistance due to the dispersant. However, when the dispersant is removed, the carbon nanotube dispersion according to the present invention showed much smaller sheet resistance than the carbon nanotube dispersion including only the solvent. Specifically, when the carbon nanotube dispersion includes a tetrafunctional ethylene oxide-propylene oxide block copolymer, low sheet resistance can be obtained. Accordingly, the dispersant does not affect electrical properties of carbon nanotubes in a carbon nanotube dispersion.

A carbon nanotube dispersion according to the present invention enables carbon nanotube dispersion in both aqueous and organic systems having excellent dispersion stability. Therefore, the carbon nanotube dispersion is suitable for a transparent electrode.

While the present invention has been shown and described with reference to exemplary embodiments thereof, it will be understood by those of ordinary skill in the art that various changes in form and details may be made therein without departing from the spirit and scope of the present invention as defined by the following claims.

1. A carbon nanotube dispersion comprising:
carbon nanotubes;
a solvent; and
a dispersant,
wherein a multifunctional ethylene oxide-propylene oxide block copolymer acts as the dispersant and the amount of carbon nanotubes is in the range from 0.001 to 0.05 parts by weight and the amount of the dispersant is in the range from 0.01 to 0.3 parts by weight, based on 100 parts by weight of the solvent.

2. The carbon nanotube dispersion of claim 1, wherein the multifunctional ethylene oxide-propylene oxide block copolymer is a difunctional ethylene oxide-propylene oxide block copolymer or a tetrafunctional ethylene oxide-propylene oxide block copolymer.

3. The carbon nanotube dispersion of claim 2, wherein the difunctional ethylene oxide-propylene oxide block copolymer is a compound represented by Formula 1 or Formula 2:
HO-{[A]ₙ-[B]ₘ}_{y}-[A]ₓ-OH; and [Formula 1]
HO-{[B]ₙ-[A]ₘ}_{y}-[B]ₓ-OH [Formula 2]
where A is an ethylene oxide repeat unit,
B is a propylene oxide repeat unit,
n, m, and x are integers where n+m+x>10, and
y is an integer where 1<y<100.

4. The carbon nanotube dispersion of claim 3, wherein B denotes an n-propylene oxide repeat unit or an isopropylene oxide repeat unit.

5. The carbon nanotube dispersion of claim 2, wherein the tetrafunctional ethylene oxide-propylene oxide block copolymer is a compound represented by Formula 3 or Formula 4: 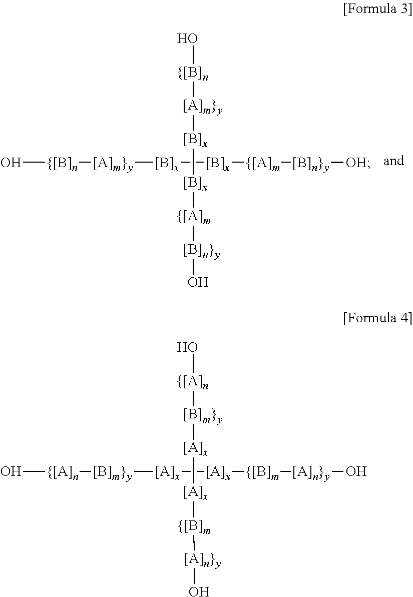
where A is an ethylene oxide repeat unit,
B is a propylene oxide repeat unit,
n, m, and x are integers where n+m+x>10, and
y is an integer where 1<y<100.

6. The carbon nanotube dispersion of claim 3, wherein B denotes an n-propylene oxide repeat unit or an isopropylene oxide repeat unit.

7. The carbon nanotube dispersion of claim 1, wherein the solvent comprises at least one selected from the group consisting of water, alcohols, amides, pyrrolidones, hydroxyesters, organic halides, nitro compounds, and nitrile compounds.

8. (canceled)

9. A method of preparing a transparent electrode, the method comprising:
preparing a carbon nanotube dispersion comprising carbon nanotubes, a solvent, and a multifunctional ethylene oxide-propylene oxide block copolymer acting as a dispersant;
coating the carbon nanotube dispersion on a transparent film; and
drying the transparent film coated with the carbon nanotube dispersion.

10. The method of claim 9, wherein the transparent film comprises a PET resin, a PES resin, or a PEN resin.

11. The method of claim 9, after the drying, further comprising removing excess dispersant.
